(19) United States
(12) Patent Application Publication
(10) Pub. No.: US 2005/0024758 A1
(43) Pub. Date: Feb. 3, 2005

(54) Recording rate setting apparatus, data recording apparatus, recording rate setting method, recording rate setting program and data recording medium

(75) Inventor: Jun Kamei, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/900,327

(22) Filed: Jul. 28, 2004

(30) Foreign Application Priority Data
Jul. 29, 2003 (JP) P2003-203368

(51) Int. Cl. H04N 5/76; G11B 5/09

(52) U.S. Cl. 360/46; 386/124

(57) ABSTRACT

A recording-rate-setting apparatus is provided with: an average recording-rate calculation device which calculates an average recording rate for recording all of the data, other than a data for which the recording rate is set, onto the medium; a judgment device which determines whether or not rate-fixed data is the other data having a data rate that is less than the calculated average recording rate; a rate-setting device which sets the recording rate that corresponds to the rate-fixed data; and a control device which controls the average recording-rate calculation device, the judgment device and the rate-setting device such that the calculation process of calculating the average recording rate by the average recording-rate calculation device, the judgment process and the setting process of setting the recording rate are repeatedly executed for all the other data, and setting the recording rate for all the other data.

### BACKGROUND OF THE INVENTION

1. Field of the Invention

This invention relates to a recording-rate-setting apparatus, data-recording apparatus, recording-rate-setting method, recording-rate-setting program and data-recording medium on which the recording-rate-setting program is recorded, and more particularly to a recording-rate-setting apparatus and recording-rate-setting method for setting the recording rate when recording data onto a recording medium; and a data-recording apparatus that comprises a recording-rate-setting program for performing a recording-rate-setting process, a data-recording medium on which the recording-rate-setting program is recorded, and the recording-rate-setting apparatus.

2. Related Art

Generally, data is transferred or copied (so-called ‘dubbing’) from one recording medium (video tape, etc.) to another recording medium (optical disc, etc.).

In a conventional dubbing process, when a plurality of kinds of data, each having their own different data rate, are recorded on one recording medium, the average recording rate for the dubbing process is calculated based on the recording capacity of the unrecorded area on the other recording medium, which will be the dubbing destination, and the recording time for each kind of data to be dubbed; and for data having a data rate that is less than that calculated average recording rate, that data itself is dubbed as is without performing a decoding process and then encoding process again; and for data having a data rate that is greater than the calculated average recording rate, a rate-conversion process is performed to lower that data rate to the average recording rate (includes the decoding and re-encoding process for that data), and then a process is performed to record that data onto another recording medium. Also, in the past, for data having a data rate that is greater than the calculated average recording rate, the aforementioned rate-conversion process is performed for all of the data, and dubbing is performed at the same average recording rate.

However, in this conventional dubbing process, since the average recording rate is uniformly set to correspond to all of the data, a rate-conversion process is performed for all data having a data rate that is greater than that average recording rate, so as a result, there was a problem in that the time required to perform that rate-conversion process was greatly increased.

Also, for data having a data rate greater than the average recording rate, rate conversion was performed so that each data rate became equal to the average recording rate, so as a result, there was a problem in that there was the possibility that the quality of the data (video quality or audio quality) could become poor due to the rate conversion.

### SUMMARY OF THE INVENTION

Taking the aforementioned problems into consideration, the object of this invention is to provide a recording-rate-setting apparatus and recording-rate-setting method for performing dubbing that shortens the amount of time required for dubbing and keeps the degradation of the data to a minimum; and a data-recording apparatus that includes a recording-rate-setting program for performing the recording-rate-setting process, a data-recording medium on which the recording-rate-setting program is recorded, and the recording-rate-setting apparatus.

The above object of the present invention can be achieved by a recording-rate-setting apparatus of the present invention. The recording-rate-setting apparatus that sets the recording rate for each of a plurality of data when recording the data onto a recording medium, is provided with: an average recording-rate calculation device which calculates an average recording rate that will be the recording rate for recording all of the data, other than a data for which the recording rate has already been set, onto the recording medium; a judgment device which determines whether or not rate-fixed data is the other data having a data rate that is less than the calculated average recording rate; a rate-setting device which sets the recording rate that corresponds to the rate-fixed data when there is the rate-fixed data to the same value as the current data rate of that rate-fixed data; and a control device which controls the average recording-rate calculation device, the judgment device and the rate-setting device such that the calculation process of calculating the average recording rate by the average recording-rate calculation device, the judgment process by the judgment device and the setting process of setting the recording rate by the rate-setting device are repeatedly executed for all the other data, and setting the recording rate for all the other data.

According to the present invention, in the operation of a recorder, the recorder calculates an average recording rate, which is a recording rate used when dubbing all of the contents, except contents for which the recording rate has already been set, onto a recording medium at the same recording rate, and it determines whether or not there are contents having a data rate that is less than that calculated average recording rate, and when there are such contents, the recording rate for the contents is set to the same value as the current data rate for those contents; and furthermore the recorder repeats the process of calculating the average recording rate, the process of determining whether or not there are contents having a data rate that is less than the calculated average recording rate, and process of setting the recording for all of the contents, so compared with the case of dubbing all of the contents with a single recording rate, it is possible to increase the contents that can be dubbed without having to perform a rate-conversion process, and thus it is possible to reduce the time required for dubbing and to prevent or suppress degradation of the video quality or audio quality when dubbing.

In one aspect of the present invention can be achieved by the recording-rate-setting apparatus of the present invention. The recording-rate-setting apparatus of the present invention, wherein the average recording-rate calculation device calculates an overall average recording rate that is the recording rate when recording all the data onto the recording medium at the same recording rate when in the initial state the recording rate corresponding to all the data has yet to be set; the rate-fixed-data-judgment device determines in the initial state whether or not there is the rate-fixed data having a data rate that is less than the calculated overall average recording rate; and the rate-setting device sets the recording rate that corresponds to the rate-fixed data to the same value as the current data rate of the rate-fixed data when there is the rate-fixed data in the initial state; and wherein the control means controls the average recording-rate calculation device, the judgment means and the rate-setting means such that after performing the initial setting of the recording rate corresponding to the rate-fixed data, the calculation process of calculating the average recording rate by the average recording-rate calculation means, the judgment process which determines whether or not there is the rate-fixed data by the judgment means and the setting process of setting the recording rate by the rate-setting means are repeatedly executed for all data other than the rate-fixed data, and sets the recording rate for all the data.

According to the present invention, in the initial state when the recording rate corresponding to all of the contents to be dubbed is not set, a recorder calculates a recording rate to be used to dub all of the contents onto a recording medium at the same recording rate as an average recording rate, and determines whether or not there are any contents having a data rate that is less than that calculated average recording rate, and when there are such contents, it sets the corresponding recording rate to the same value as the current data rate of the contents and performs dubbing, so dubbing is performed very efficiently and it is possible to prevent or suppress degradation of the video quality or audio quality due to dubbing.

In another aspect of the present invention can be achieved by the recording-rate-setting apparatus of the present invention. The recording-rate-setting apparatus of the present invention is, wherein the average recording-rate calculation means calculates either the average recording rate or the overall average recording rate based on the total amount of data for the data before setting the recording rate and the recording capacity for the data on the recording medium.

According to the present invention, the average recording rate is calculated based on the total amount of data of the contents before setting the recording rate and the recording capacity of the area on the recording medium where the contents are to be dubbed to, so it is possible to easily calculate the average recording rate each time.

In further aspect of the present invention can be achieved by the recording-rate-setting apparatus of the present invention. The recording-rate-setting apparatus of the present invention is, wherein there is a plurality of the recording medium; and is further provided with: a specification device which specifies one of the recording medium onto which the data is to be recorded; and wherein the average recording-rate calculation device calculates either the average recording rate or the overall average recording rate based on the total amount of data for the data before setting the recording rate and the recording capacity for the data on the specified recording medium.

According to the present invention, the case of only one recording medium as the dubbing destination was explained, however, besides this, it is also possible to apply the invention to the case where there is a plurality of recording medium as dubbing destinations, and the dubbing is performed by exchanging these recording mediums. In this case, so-called disc-management data is used to calculate the average recording rate for each time. In other words, as disc-management data, the titles of each recording medium, the already recorded amount, and the un-recorded amount of space on each recording mediums are stored in a memory or on a hard disc at attribute data for each of the plurality of recording medium. Disc-management data that corresponds to the recording medium that is the dubbing destination is selected from among the plurality of recorded disc-management data, and the recording capacity of the area provided for dubbing on the recording medium that corresponds to the selected disc-management data is obtained from that disc-management data, and that obtained recording capacity is set in a CPU as the recording capacity to be used in the processing. Also, during actual dubbing, the recording medium that is the object of that dubbing is mounted in the recording drive apparatus and dubbing is executed. In this case, it is possible to execute dubbing using a plurality of recording medium in a short period of time, and it is possible to keep degradation of the video quality and audio quality to a minimum. Besides this, it is also possible to apply the invention to dubbing between hard discs, or dubbing between DVDs, or dubbing from a DVD to a hard disc or from a hard disc to a DVD. Furthermore, it is also possible to apply the invention to dubbing between other recording medium other than a DVD or hard disc.

In further aspect of the present invention can be achieved by the recording-rate-setting apparatus of the present invention. The recording-rate-setting apparatus of the present invention is further provided with: a memory device which stores the recording capacity of each the recording medium as management data for each respective recording medium; and wherein the average recording-rate calculation device reads the recording capacity for each of the data on a specified recording medium when one of the recording medium is specified from the memory means as the recording capacity.

According to the present invention, it is possible to execute dubbing using a plurality of recording medium in a short period of time, and it is possible to keep degradation of the video quality and audio quality to a minimum. Besides this, it is also possible to apply the invention to dubbing between hard discs, or dubbing between DVDs, or dubbing from a DVD to a hard disc or from a hard disc to a DVD. Furthermore, it is also possible to apply the invention to dubbing between other recording medium other than a DVD or hard disc.

In further aspect of the present invention can be achieved by the recording-rate-setting apparatus of the present invention. The recording-rate-setting apparatus of the present invention is, wherein when the judgment means determines in the judgment process that there is no the rate-fixed data, the recording rate of the data for which the recording rate is not set is set to either the average recording rate that was calculated just previously or to the overall average recording rate.

According to the present invention, when there are no contents having a data rate that is less than the average recording rate for that time, the most recently calculated recording rate is taken to be the recording rate for contents whose recording rate has not been set, so it is possible to dub all of the content while keeping degradation of video quality or audio quality to a minimum.

The above object of the present invention can be achieved by a recording-rate-setting method of the present invention. The recording-rate-setting method of setting the recording rate for each of a plurality of data when recording the data onto a recording medium, is provided with: an average recording-rate calculation process of calculating an average recording rate that will be the recording rate for recording all of the data, other than the data for which the recording rate has already been set, onto the recording medium; a judgment process of determining whether or not rate-fixed data is the other data having a data rate that is less than the calculated average recording rate; a rate-setting process of setting the recording rate that corresponds to the rate-fixed data when there is the rate-fixed data to the same value as the current data rate of that rate-fixed data; and a control process of performing control such that the calculation process of calculating the average recording rate, the judgment process of determining whether or not there is any the rate-fixed data and the setting process of setting the recording rate are repeatedly executed for all the other data, and setting the recording rate.

According to the present invention, in the operation of a recorder, the recorder calculates an average recording rate, which is a recording rate used when dubbing all of the contents, except contents for which the recording rate has already been set, onto a recording medium at the same recording rate, and it determines whether or not there are contents having a data rate that is less than that calculated average recording rate, and when there are such contents, the recording rate for the contents is set to the same value as the current data rate for those contents; and furthermore the recorder repeats the process of calculating the average recording rate, the process of determining whether or not there are contents having a data rate that is less than the calculated average recording rate, and process of setting the recording for all of the contents, so compared with the case of dubbing all of the contents with a single recording rate, it is possible to increase the contents that can be dubbed without having to perform a rate-conversion process, and thus it is possible to reduce the time required for dubbing and to prevent or suppress degradation of the video quality or audio quality when dubbing.

The above object of the present invention can be achieved by a recording-rate-setting program of the present invention. The recording-rate-setting program that makes a computer that is included in a recording-rate-setting apparatus of setting the recording rate for each of a plurality of data when recording the data onto a recording medium, function as: an average recording-rate calculation device which calculates an average recording rate that is the recording rate for recording all of the data, other than the data for which the recording rate is set, onto the recording medium; a judgment device which determines whether or not rate-fixed data is the other data having a data rate that is less than the calculated average recording rate; a rate-setting device which sets the recording rate that corresponds to the rate-fixed data when there is the rate-fixed data to the same value as the current data rate of that rate-fixed data; and a control device which performs control such that the calculation process of calculating the average recording rate, the judgment process of determining whether or not there is any the rate-fixed data and the setting process of setting the recording rate are repeatedly executed for all the other data, and setting the recording rate.

According to the present invention, in the operation of a recorder, the recorder calculates an average recording rate, which is a recording rate used when dubbing all of the contents, except contents for which the recording rate has already been set, onto a recording medium at the same recording rate, and it determines whether or not there are contents having a data rate that is less than that calculated average recording rate, and when there are such contents, the recording rate for the contents is set to the same value as the current data rate for those contents; and furthermore the recorder repeats the process of calculating the average recording rate, the process of determining whether or not there are contents having a data rate that is less than the calculated average recording rate, and process of setting the recording for all of the contents, so compared with the case of dubbing all of the contents with a single recording rate, it is possible to increase the contents that can be dubbed without having to perform a rate-conversion process, and thus it is possible to reduce the time required for dubbing and to prevent or suppress degradation of the video quality or audio quality when dubbing.

### BRIEF DESCRIPTION OF THE DRAWINGS

FIG. 1 is a block diagram showing the construction of the recorder of an embodiment of the invention;

FIG. 2 is a flowchart showing the dubbing process of an embodiment of the invention;

FIG. 3A is a drawing showing a first example of the contents of the processing of step S6;

FIG. 3B is a drawing showing a second example of the contents of the processing of step S6;

FIG. 3C is a drawing showing a third example of the contents of the processing of step S6; and

FIG. 3D is a drawing showing an example of the recording rates set for each of the contents.

### DESCRIPTION OF THE PREFERRED EMBODIMENT

Next, the preferred embodiment of the invention will be explained based on the drawings. The embodiment described below is an embodiment in which the invention is applied to a recorder that dubs a plurality of data (hereafter, the data will be referred to as the contents) such as video images, which are recorded onto a hard disc, onto DVD (Digital Versatile Disc).

(I) Overall Construction and Operation

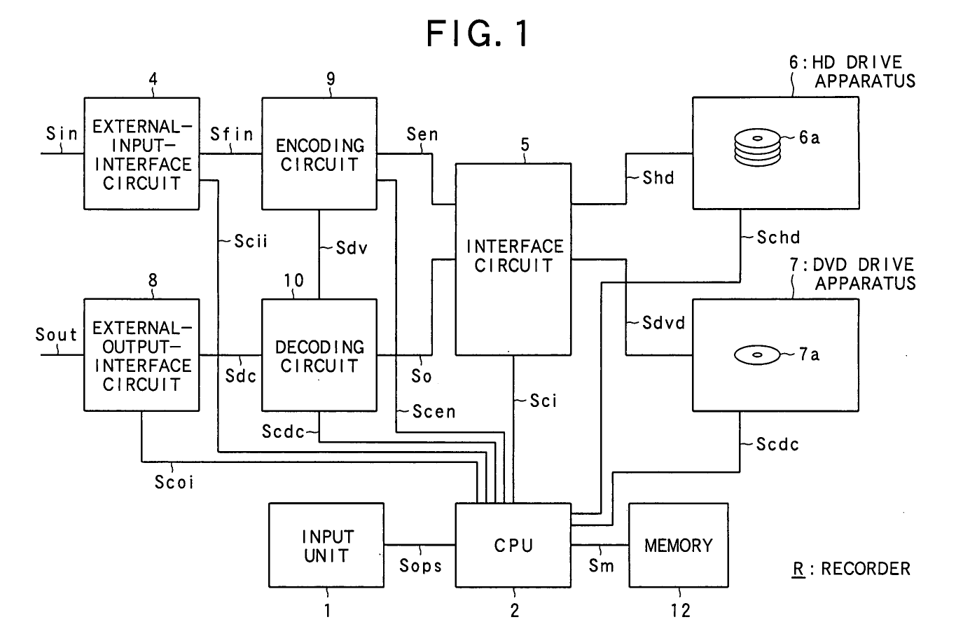

First, FIG. 1 will be used to explain the overall construction of a recorder as the data-recording apparatus of this embodiment. FIG. 1 is a block diagram showing the construction of the recorder of this embodiment.

As shown in FIG. 1, the recorder R of this embodiment comprises; a CPU 2 that functions as an input unit 1 of a specification means, an average-recording-rate-calculation means, judgment means, rate-setting means and control means; an external-input-interface circuit 4; interface circuit 5; a hard-disc (hereafter, referred to as HD) drive apparatus 6 that that is capable of recording data onto or reproducing data from an internal HD 6a; a DVD drive apparatus 7 that is capable of recording data onto or reproducing data from a DVD 7a that is the mounted recording medium; an external-output-interface unit 8; an encoding circuit 9; a decoding circuit 10; and a memory 12 as a memory means.

Next, the overall operation will be explained.

The recorder R of this embodiment is capable of recording data, such as a broadcast program that was received by way of a broadcast signal, onto a hard disc 6a or DVD 7a or both, and detecting and reproducing either or both of the recorded data and outputting it to a display or speaker (not shown in the figure).

First, the overall operation of recording to at least a hard disc 6a or DVD 7a or both will be explained.

Input data Sin that is obtained as data to be recorded onto the hard disc 6a undergoes a preset input-interface process by the external-input-interface unit 4 based on a control signal Scii from the CPU 2, and is then output to the encoding circuit 9 as processed-input data Sfin.

The encoder circuit 9 performs a preset encoding process on the input processed-input data Sfin based on a control signal Scen from the CPU 2 to generate encoded data Sen, and outputs it to the interface circuit 5.

Next, based on a control signal Sci from the CPU 2, the interface circuit 5 performs a conversion process on the input encoded data Sen to convert it to a recording format that corresponds to the recording destination (that is, either the hard disc 6a or DVD 7a, or both), and according to the recording destination, outputs either hard disc data Shd to the HD drive apparatus 6 or DVD data Sdvd to the DVD drive apparatus 7, or both.

The recording unit (not shown in the figures) inside the HD drive apparatus 6 to which the hard disc data Shd is input, records the hard disc data Shd (or in other words, encoded data Sen) to the hard disc 6a based on a control signal Schd from the CPU 2.

On the other hand, the recording unit (not shown in the figures) inside the DVD drive apparatus 7 to which the DVD data is input, records the DVD data Sdvd (or in other words, encoded data Sen) to the DVD 7a based on a control signal Scdc from the CPU 2.

Next, the overall operation in the case of reproducing and outputting the data recorded on the hard disc 6a will be explained.

In the case of reproducing and outputting the data recorded on the hard disc 6a, first, based on a control signal Schd from the CPU 2, the reproduction unit (not shown in the figures) inside the HD drive apparatus 6 detects the data recorded on the hard disc 6a, and outputs the detected signal to the interface circuit 5 as hard disc data Shd.

Also, based on a control signal Sci from the CPU 2, the interface circuit 5 performs a process such as the necessary format conversion for the hard disc data Shd and outputs it to the decoding circuit 10 as output data So.

Next, based on a control signal Scdc from the CPU 2, the decoding circuit 10 decodes the output data So to generate decoded data Sdc, and outputs it to the external-output-interface circuit 8.

Also, based on a control signal Scoi from the CPU 2, the external-output-interface circuit 8 performs a preset output-interface process on the decoded data Sdc to generate external-output data Sout, and outputs it to a display or speaker (not shown in the figures). In this way, the video or audio, which is the data that was recorded on the hard disc 6a, is reproduced.

Finally, the overall operation in the case of reproducing the data recorded on the DVD 7a will be explained.

In the case of reproducing and outputting the data recorded on the DVD 7a, first, based on a control signal Scdc from the CPU 2, the reproduction unit (not shown in the figure) inside the DVD drive apparatus 7 detects data recorded on the DVD 7a, and outputs the detected signal to the interface circuit 5 as DVD data Sdvd.

Also, based on a control signal Sci from the CPU 2, the interface circuit 5 performs a process on the DVD data Sdvd such as the necessary format conversion process, and outputs it to the decoding circuit as output data So.

Next, based on a control signal Scdc from the CPU 2, the decoding circuit 10 decodes the output data So to generate decoded data Sdc, and outputs it to the external-output-interface circuit 8.

Also, based on a control signal Scoi from the CPU 2, the external-output-interface circuit 8 performs a preset output-interface process on the decoded data Sdc to generate external-output data Sout, and outputs it to a display or speaker (not shown in the figures). In this way, the video or audio, which is the data that was recorded on the DVD 7a, is reproduced.

In the embodiment to be explained below, when dubbing from the hard disc 6a to the DVD 7a and dubbing is performed without performing the rate-conversion process, the contents that are the object of that dubbing are detected by the detection unit (not shown in the figures) in the HD drive apparatus 6 and then output to the interface circuit 5 as hard disc data Shd, after which the contents are output to the DVD drive apparatus 7 as they are as DVD data Sdvd and recorded on the DVD 7a.

On the other hand, when performing that dubbing together with performing the rate-conversion process, the contents that are the object of that dubbing are detected by the detection unit (not shown in the figures) in the HD drive apparatus 6 and then output to the interface circuit 5 as hard disc data Shd, after which a process such as format conversion is performed and the contents are output to the decoding circuit 10 as output data So.

Also, after the necessary decoding process is performed by the decoding circuit 10, the data is output to the encoding circuit 9 as dubbing data Sdv, and the encoding circuit 9 executes the necessary encoding process (rate-conversion process) and generates encoded data Sen. Next, that encoded data is output to the DVD drive apparatus 7 as DVD data Sdvd by way of the interface circuit 5 and recorded on the DVD 7a.

Here, the operation for controlling the overall operation described above is executed by the input unit 1 that comprises a button-control unit or remote-control unit, and this input unit 1 outputs a control signal Sops to the CPU 2 that corresponds to the controls.

Also, based on that control signal Sops, the CPU 2 generates control signals Scoi, Scii, Scen, Schd, Scdc, Schd and Sci for controlling the components of the recorder such that the operations corresponding to the controls executed from the input unit 1 are executed and outputs the signals to the respective components. Also, data necessary for processing by the CPU 2 is output to the memory 12 as a memory signal Sm and stored temporarily, and when needed, the data is read from the memory 12 as a reproduction-memory signal Sm and supplied to the process by the CPU 2.

(II) Embodiment

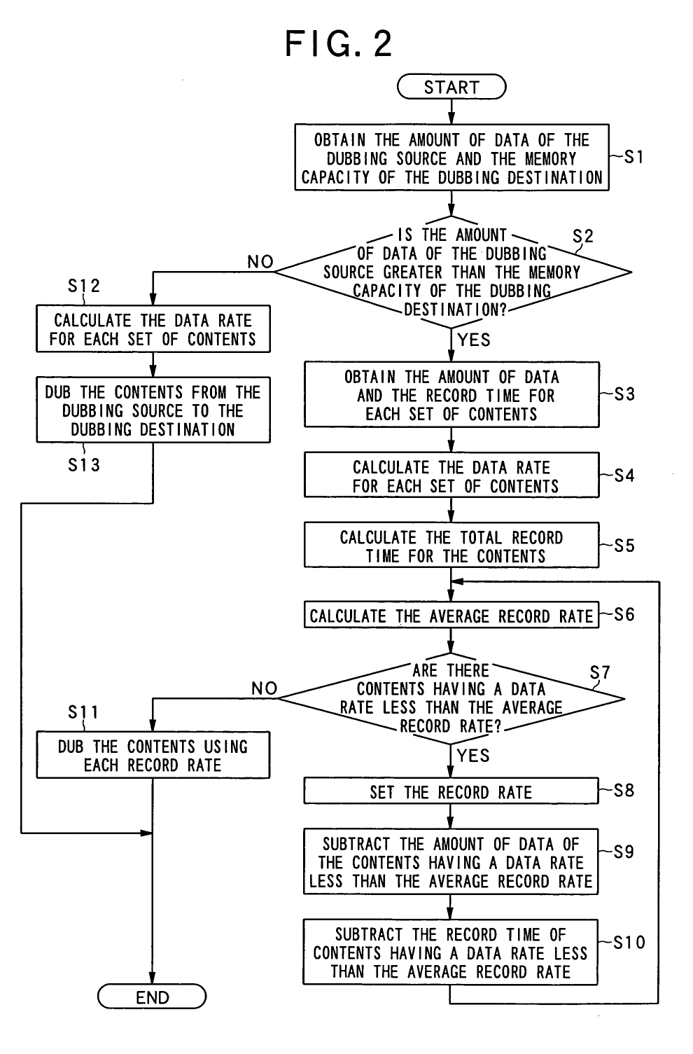

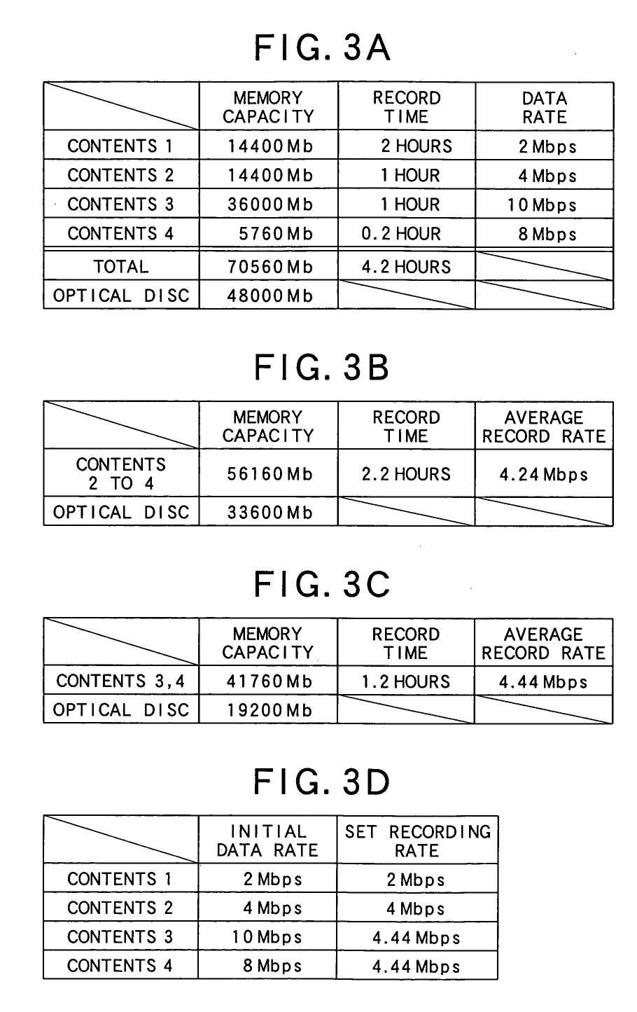

Next, the dubbing process of this embodiment that dubs contents under the control of the CPU 2 will be explained using FIG. 1 to FIG. 3. FIG. 2 is a flowchart showing the dubbing process of this embodiment, and FIG. 3A to FIG. 3D are detailed examples of the dubbing process.

Also, the embodiment described below is an embodiment in which the invention is applied to a process of dubbing contents, which are already recorded on the hard disc 6a and that have different data rates, onto a DVD 7a.

As shown in FIG. 2, in the dubbing process of this embodiment, first, the amount of data of all of the contents that are recorded on the dubbing source or hard disc 6a and that are the object of the dubbing process is detected for each set of contents, and at the same time, the recordable capacity of the recording area on the dubbing destination or DVD 7a where the contents will be recorded is detected (step S1).

At this time, the amount of data for each of the contents to be dubbed is output from the HD drive apparatus 6 to the CPU 2 byway of the interface circuit 5. Also, the recordable capacity of the dubbing destination or DVD 7a is output from the DVD drive apparatus 7 to the CPU 2 by way of the interface circuit 5.

Next, the total data amount of all of the detected contents is compared with the detected recordable capacity (step S2). When the total amount of data of all of the contents to be dubbed is less than the recordable capacity (step S2: NO), all of the contents can be dubbed without performing the rate-conversion process (in other words, the video quality or audio quality will not be degraded), so the CPU 2 calculates the data rates for each of the contents by dividing the data amount for each of the contents by the respective recording time (step S12), and then by using each of the calculated data rates, dubs each of the respective contents onto the DVD 7a (step S13) and ends the dubbing process of this embodiment.

Here, in the flow of data in this dubbing process, after the data is output from the HD drive apparatus 6, the interface circuit 5 performs the necessary format conversion and immediately outputs the data to the DVD drive apparatus 7, and that data is recorded onto the DVD 7a.

On the other hand, in the judgment of step S2, when the total amount of data of all of the contents to be dubbed is greater than the recordable capacity (step S2: YES), it is necessary to perform a rate-conversion process on some of the contents, so next, the amount of data for each of the contents and the respective recording times are obtained from the HD drive apparatus 6 by way of the interface circuit 5 (step S3), and furthermore, the CPU 2 divides the amounts of data of each of the contents by the respective recording times to calculate the data rates for each of the contents (step S4).

Also, the CPU 2 calculates the total recording time for all of the contents to be dubbed (step S5), and then divides the recordable capacity on the DVD 7a by the total recording time for the contents. By doing this, the first average recording rate for dubbing all of the contents to be dubbed onto the DVD 7a from the hard disc 6a is found (step S6).

Next, the average recording rate that was calculated first is compared with the data rates for each of the contents to be dubbed (see step S4) to determine whether or not there are any contents having a data rate that is less than the average recording rate (step S7). When there are no contents having a data rate that is less than the average recording rate (step S7: NO), then there are no contents that can be dubbed without performing rate conversion, so rate conversion processing is performed until the data rates of the contents become equal to the average recording rate that was calculated in step S6, then the contents are dubbed onto the DVD 7a (step S11) and the dubbing process of this embodiment ends.

On the other hand, in the judgment of step S7, when there is at least one set of contents having a data rate that is less than the average recording rate (step S7: YES), the recording rate when dubbing a set of contents having a data rate that is less than the average recording rate is set to the same value as the data rate of that set of contents (step S8), and next, the total amount of data for contents having data rates that are less than the average recording rate is subtracted from the total amount of data of contents to be dubbed (step S9), and furthermore, the total recording time of contents having data rates that are less than the average recording rate is subtracted from the total recording time of contents to be dubbed (step S10).

From the subtraction processes in steps S9 and S10, the total amount of data and total recording time of contents that cannot be dubbed at the currently calculated average recording rate (see step S6) without performing a rate-conversion process are found, so next the processing of steps S6 to S10 are performed on the contents that cannot be dubbed at the currently calculated average recording rate without performing a rate-conversion process.

In other words, the recordable capacity on the DVD 7a for recording the contents that cannot be dubbed at the currently calculated average recording rate without performing a rate-conversion process is divided by the total recording time for those contents to calculate a second average recording rate (step S6), and the calculated average recording rate is compared with the data rates of each of the remaining contents for which a recording rate has not been set (see step S4) to determine whether or not there are contents having a data rate that is less than that average recording rate (step S7). When there are no contents having a data rate that is less than that average recording rate (step S7: NO), then there are no contents that can be dubbed at the current recording rate without performing rate conversion, so a rate-conversion process is performed until the data rates of the contents equal the second average recording rate that was calculated in step S6, and those contents are then dubbed onto the DVD 7a (step S11) and the dubbing process of this embodiment ends.

On the other hand, in the judgment of step S7, when there is at least one set of contents having a data rate that is less than the second average recording rate (step S7: YES), then the recording rate when dubbing the set of contents having a data rate that is less than the second average recording rate is set to the same value as the data rate of that set of contents (step S8), and next, the total amount of data for contents having data rates that are less than the second average recording rate is subtracted from the total amount of data of contents to be dubbed (step S9), and furthermore, the total recording time of contents having data rates that are less than the second average recording rate is subtracted from the total recording time of contents to be dubbed (step S10).

From the subtraction processes in steps S9 and S10, the total amount of data and total recording time of contents that cannot be dubbed at the second average recording rate without performing a rate-conversion process are found, so next the processing of steps S6 to S10 are performed on the contents that cannot be dubbed at this second average recording rate without performing a rate-conversion process.

By repeating the steps S6 to S10 until recording rates have been set for all of the contents, the data rates of the contents are converted to rates that correspond to the average recording rates that were calculated in stages and dubbing is performed, or the data rates are not converted and the contents are dubbed as they are.

Next, the detailed flow of the dubbing process shown in FIG. 2 will be explained using FIGS. 3A to 3D. FIG. 3A is a drawing showing an example of the data of each of the contents obtained in the processing of step S5 of FIG. 2; FIG. 3B is a drawing showing the contents, which are the object of the calculation process for the next average recording rate after the processing of steps S9 and S10 has been performed based on the example shown in FIG. 3A, and the calculation results; FIG. 3C is a drawing showing the contents, which are the object of the calculation process for the next average recording rate after the processing of steps S9 and S10 has been performed based on the data shown in FIG. 3B, and the calculation results; and FIG. 3D is a drawing showing a comparison between the initial recording rates for each of the contents before the processing of this embodiment and the recording rates after the processing.

First, as shown in FIG. 3A, four sets of contents are recorded on the hard disc 6a as the object of the dubbing process of this invention, and the amount of data, recording times and data rates of each of the four sets of contents are obtained (see steps S3 and S4 in FIG. 2).

More specifically, for contents 1, the amount of data is 14,400 Mb (Mega bits), the recording time is 2 hours and the recording rate (or in other words the data rate divided by the recording time) is given by Equation 1.
14,400 Mb/(2 hours×60 min/hour×60 sec/min)=Approximately 2 Mbps(Mega bits per second) [Equation 1]

Also, for contents 2, the amount of data is 14,400 Mb, the recording time is 1 hour and the recording rate is given by Equation 2.
14,400 Mb/(1 hour×60 min/hour×60 sec/min)=Approximately 4 Mbps [Equation 2]

Moreover, for contents 3, the amount of data is 36,000 Mb (Mega bits), the recording time is 1 hour and the recording rate is given by Equation 3.
36,000 Mb/(1 hour×60 min/hour×60 sec/min)=Approximately 10 Mbps [Equation 3]

Furthermore, for contents 4, the amount of data is 5,760 Mb (Megabits), the recording time is 0.2 hour and the recording rate is given by Equation 4.
5,760 Mb/(0.2 hour×60 min/hour×60 sec/min)=Approximately 8 Mbps [Equation 4]

From this, the total recording time at this point in time for contents 1 to 4 is 4.2 hours.

Here, the recording capacity of the area on the DVD 7a where the contents 1 to 4 are to be dubbed, is 48,000 Mb for example, and the first average recording rate found in the process of step 6 is given by Equation 5.
48,000 Mb/4.2 hours=Approximately 3.17 Mbs [Equation 5]

From this is, it is seen that at the current time the contents 1 are contents having a data rate that is less than 3.17 Mbs or the first average recording rate. Therefore, in this case, the contents 1 become the object of dubbing and the recording rate for dubbing the contents 1 onto the DVD 7a is set as is at 2 Mbps (see step S8 in FIG. 2), and the processing of steps S9 and S10 is performed for the other contents 2 to 4.

Next, the results of performing the processing of steps S9 and S10 for the contents 2 to 4 are shown in FIG. 3B.

In other words, the total recording time for the contents 2 to 4 becomes 2.2 hours, and the recording capacity of the area on the DVD 7a where the contents 2 to 4 are to be dubbed becomes 33,600 Mb, which is the value of the amount of data of contents 1 subtracted from the initial recording capacity of the recording area (48,000 Mb-14,400 Mb). From this, a second average recording rate is found for contents 2 to 4 in the processing of step S6 and is given by Equation 6.

33,600 Mb/2.2 hours=Approximately 4.24 Mbs [Equation 6]

Next, contents 2 are contents having a data rate that is less than the second average recording rate of 4.24 Mbs. Therefore, in this case, the contents 2 become the object of dubbing and the recording rate for dubbing contents 2 onto the DVD 7a is set as is at 4 Mbps (see step S8 in FIG. 2), and the processing of steps S9 and S10 is performed for the other contents 3 and 4.

Next, the results of performing the processing of steps S9 and S10 for the contents 3 and 4 are shown in FIG. 3C.

In other words, the total recording time for the contents 3 and 4 becomes 1.2 hours, and the recording capacity of the area on the DVD 7a where the contents 3 and 4 are to be dubbed becomes 19,200 Mb, which is the value of the amount of data of contents 1 and 2 subtracted from the initial recording capacity of the recording area (48,000 Mb-14,400 Mb-14,400 Mb). From this, a third average recording rate is found for contents 3 and 4 in the processing of step S6 and is given by Equation 7.
19,200 Mb/1.2 hours=Approximately 4.44 Mbs [Equation 7]

Next, there are no contents having a data rate that is less than the third average recording rate of 4.44 Mbs and both the data rates of the remaining contents 3 and 4 are greater than the third average recording rate of 4.44 Mbs (FIG. 2, step S7: NO), so in this case the process goes to step S11.

As a result of the series of processes described above, the values of the recording rates set for the four sets of contents are as shown in FIG. 3D. Also, in step S1, the recording rate for contents 1 is set to 2 Mbps and the recording rate for contents 2 is set to 4 Mbps, and they are dubbed from the hard disc 6a to the DVD 7a without performing a rate-conversion process.

On the other hand, for contents 3 and 4, in the same step S1, the recording rate is set to the last (third) calculated average recording rate of 4.44 Mbs, and a rate conversion process is performed in dubbing the contents 3 and 4 from the hard disc 6a to the DVD 7a.

As explained above, in the operation of the recorder R of this embodiment, the recorder R calculates an average recording rate, which is a recording rate used when dubbing all of the contents, except contents for which the recording rate has already been set, onto the DVD 7a at the same recording rate, and it determines whether or not there are contents having a data rate that is less than that calculated average recording rate, and when there are such contents, the recording rate for the contents is set to the same value as the current data rate for those contents; and furthermore the recorder R repeats the process of calculating the average recording rate, the process of determining whether or not there are contents having a data rate that is less than the calculated average recording rate, and process of setting the recording for all of the contents, so compared with the case of dubbing all of the contents with a single recording rate, it is possible to increase the contents that can be dubbed without having to perform a rate-conversion process, and thus it is possible to reduce the time required for dubbing and to prevent or suppress degradation of the video quality or audio quality when dubbing.

Also, in the initial state when the recording rate corresponding to all of the contents to be dubbed is not set, the recorder R calculates a recording rate to be used to dub all of the contents onto the DVD 7a at the same recording rate as an average recording rate, and determines whether or not there are any contents having a data rate that is less than that calculated average recording rate, and when there are such contents, it sets the corresponding recording rate to the same value as the current data rate of the contents and performs dubbing, so dubbing is performed very efficiently and it is possible to prevent or suppress degradation of the video quality or audio quality due to dubbing.

Moreover, the average recording rate is calculated based on the total amount of data of the contents before setting the recording rate and the recording capacity of the area on the DVD 7a where the contents are to be dubbed to, so it is possible to easily calculate the average recording rate each time.

Furthermore, when there are no contents having a data rate that is less than the average recording rate for that time, the most recently calculated recording rate is taken to be the recording rate for contents whose recording rate has not been set, so it is possible to dub all of the content while keeping degradation of video quality or audio quality to a minimum.

In the embodiment described above, the case of only one DVD 7a as the dubbing destination was explained, however, besides this, it is also possible to apply the invention to the case where there is a plurality of DVDs 7a as dubbing destinations, and the dubbing is performed by exchanging these DVDs 7a.

In this case, so-called disc-management data is used to calculate the average recording rate for each time. In other words, as disc-management data, the titles of each DVD 7a, the already recorded amount, and the un-recorded amount of space on each DVD 7a are stored in the memory 12 or on the hard disc 6a at attribute data for each of the plurality of DVDs 7a.

Disc-management data that corresponds to the DVD 7a that is the dubbing destination is selected from among the plurality of recorded disc-management data, and the recording capacity of the area provided for dubbing on the DVD 7a that corresponds to the selected disc-management data is obtained from that disc-management data, and that obtained recording capacity is set in the CPU 2 as the recording capacity to be used in the processing of step S2 shown in FIG. 2, then the process moves to the processing of step S3 on.

Also, during actual dubbing, the DVD 7a that is the object of that dubbing is mounted in the DVD drive apparatus 7 and dubbing is executed.

In this case, it is possible to execute dubbing using a plurality of DVDs 7a in a short period of time, and it is possible to keep degradation of the video quality and audio quality to a minimum.

Moreover, in the embodiment described above, the case in which dubbing of contents from the hard disc 6a to the DVD 7a was explained, however, besides this, it is also possible to apply the invention to dubbing between hard discs, or dubbing between DVDs, or dubbing from a DVD to a hard disc.

Furthermore, it is also possible to apply the invention to dubbing between other recording medium other than a DVD or hard disc.

Also, a program corresponding to the flowchart shown in FIG. 2 can be stored beforehand on a flexible disc, or can be recorded beforehand by way of a network such as the Internet, and by reading and executing the program by a general-purpose microcomputer, it is possible to have the computer function as the CPU 2 of this embodiment.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-203368 filed on Jul. 29, 2003 including the specification, claims, drawings and summary are incorporated herein by reference in its entirety.

1. A recording-rate-setting apparatus that sets the recording rate for each of a plurality of data when recording said data onto a recording medium, comprising:
an average recording-rate calculation device which calculates an average recording rate that is the recording rate for recording all of said data, other than a data for which said recording rate has already been set, onto said recording medium;
a judgment device which determines whether or not rate-fixed data is said other data having a data rate that is less than said calculated average recording rate;
a rate-setting device which sets said recording rate that corresponds to said rate-fixed data when there is said rate-fixed data to the same value as the current data rate of that rate-fixed data; and
a control device which controls said average recording-rate calculation device, said judgment device and said rate-setting device such that the calculation process of calculating the average recording rate by said average recording-rate calculation device, the judgment process by said judgment device and the setting process of setting the recording rate by said rate-setting device are repeatedly executed for all said other data, and setting said recording rate for all said other data.

2. The recording-rate-setting apparatus according to claim 1, wherein
said average recording-rate calculation device calculates an overall average recording rate that is the recording rate when recording all said data onto said recording medium at the same recording rate when in the initial state said recording rate corresponding to all said data has yet to be set;
said rate-fixed-data-judgment device determines in said initial state whether or not there is said rate-fixed data having a data rate that is less than said calculated overall average recording rate; and
said rate-setting device sets said recording rate that corresponds to the rate-fixed data to the same value as the current data rate of the rate-fixed data when there is said rate-fixed data in the initial state; and wherein
said control means controls said average recording-rate calculation device, said judgment means and said rate-setting means such that after performing the initial setting of said recording rate corresponding to said rate-fixed data, the calculation process of calculating the average recording rate by said average recording-rate calculation means, the judgment process which determines whether or not there is said rate-fixed data by said judgment means and the setting process of setting the recording rate by said rate-setting means are repeatedly executed for all data other than said rate-fixed data, and sets said recording rate for all said data.

3. The recording-rate-setting apparatus according to claim 1, wherein
said average recording-rate calculation means calculates either said average recording rate or said overall average recording rate based on the total amount of data for said data before setting said recording rate and the recording capacity for the data on said recording medium.

4. The recording-rate-setting apparatus according to claim 3, wherein there is a plurality of said recording medium; and further comprising:
a specification device which specifies one of said recording medium onto which said data is to be recorded; and wherein
said average recording-rate calculation device calculates either said average recording rate or said overall average recording rate based on the total amount of data for said data before setting said recording rate and the recording capacity for the data on said specified recording medium.

5. The recording-rate-setting apparatus according to claim 4 further comprising:
a memory device which stores said recording capacity of each said recording medium as management data for each respective recording medium; and wherein
said average recording-rate calculation device reads the recording capacity for each of said data on a specified recording medium when one of said recording medium is specified from said memory means as said recording capacity.

6. The recording-rate-setting apparatus according to claim 1, wherein
when said judgment means determines in the judgment process that there is no said rate-fixed data, the recording rate of said data for which said recording rate is not set is set to either said average recording rate that was calculated just previously or to the overall average recording rate.

7. A data-recording apparatus comprising:
a recording means of recording said data to be recorded on said recording medium at said recording rate that was set to correspond to that data; and
a recording-rate-setting apparatus that sets the recording rate for each of a plurality of data when recording said data onto a recording medium, comprising:
an average recording-rate calculation device which calculates an average recording rate that will be the recording rate for recording all of said data, other than said data for which said recording rate has already been set, onto said recording medium;
a judgment device which determines whether or not rate-fixed data is said other data having a data rate that is less than said calculated average recording rate;
a rate-setting device which sets said recording rate that corresponds to said rate-fixed data when there is said rate-fixed data to the same value as the current data rate of that rate-fixed data; and
a control device which controls said average recording-rate calculation device, said judgment device and said rate-setting device such that the calculation process of calculating the average recording rate by said average recording-rate calculation device, the judgment process by said judgment device and the setting process of setting the recording rate by said rate-setting device are repeatedly executed for all said other data, and setting said recording rate for all said other data.

8. A recording-rate-setting method of setting the recording rate for each of a plurality of data when recording said data onto a recording medium, comprising:
an average recording-rate calculation process of calculating an average recording rate that will be the recording rate for recording all of said data, other than said data for which said recording rate has already been set, onto said recording medium;
a judgment process of determining whether or not rate-fixed data is said other data having a data rate that is less than said calculated average recording rate;
a rate-setting process of setting said recording rate that corresponds to said rate-fixed data when there is said rate-fixed data to the same value as the current data rate of that rate-fixed data; and
a control process of performing control such that the calculation process of calculating said average recording rate, the judgment process of determining whether or not there is any said rate-fixed data and the setting process of setting said recording rate are repeatedly executed for all said other data, and setting said recording rate.

9. A recording-rate-setting program that makes a computer that is included in a recording-rate-setting apparatus of setting the recording rate for each of a plurality of data when recording said data onto a recording medium, function as:
an average recording-rate calculation device which calculates an average recording rate that is the recording rate for recording all of said data, other than said data for which said recording rate is set, onto said recording medium;
a judgment device which determines whether or not rate-fixed data is said other data having a data rate that is less than said calculated average recording rate;
a rate-setting device which sets said recording rate that corresponds to said rate-fixed data when there is said rate-fixed data to the same value as the current data rate of that rate-fixed data; and
a control device which performs control such that the calculation process of calculating said average recording rate, the judgment process of determining whether or not there is any said rate-fixed data and the setting process of setting said recording rate are repeatedly executed for all said other data, and setting said recording rate.

10. An information recording medium in which a recording-rate-setting program is recorded in a readable way by a recording computer included in a recording-rate-setting apparatus which, the recording-rate-setting program causing the recording computer to function as:
an average recording-rate calculation device which calculates an average recording rate that is the recording rate for recording all of said data, other than said data for which said recording rate is set, onto said recording medium;
a judgment device which determines whether or not rate-fixed data is said other data having a data rate that is less than said calculated average recording rate;
a rate-setting device which sets said recording rate that corresponds to said rate-fixed data when there is said rate-fixed data to the same value as the current data rate of that rate-fixed data; and
a control device which performs control such that the calculation process of calculating said average recording rate, the judgment process of determining whether or not there is any said rate-fixed data and the setting process of setting said recording rate are repeatedly executed for all said other data, and setting said recording rate.

11. A recording-rate-setting apparatus that sets the recording rate for each of a plurality of data, said date having unique rate-fixed date, the recording-rate-setting apparatus comprising:
an average recording-rate calculation device which calculates an average recording rate that is the recording rate for recording all of data other than a data for which said recording rate has already been set;
a judgment device which determines whether or not the rate-fixed data, which is less than said calculated average recording rate, exists;
a rate-setting device which sets said recording rate that corresponds to the current date rate of said rate-fixed data when the judgment device determines the rate-fixed date exists; and
a control device which controls said average recording-rate calculation device, said judgment device and said rate-setting device such that the calculation process of calculating the average recording rate by said average recording-rate calculation device, the judgment process by said judgment device and the setting process of setting the recording rate by said rate-setting device are repeatedly executed for all said other data, and setting said recording rate for all said other data.
